(19) United States
(12) Patent Application Publication
(10) Pub. No.: US 2003/0118680 A1
(43) Pub. Date: Jun. 26, 2003

(54) Jig structure for an integrated circuit package

(76) Inventors: Chief Lin, Hsinchu Hsien (TW); C. S. Cheng, Hsinchu Hsien (TW); Allis Chen, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/027,538

(22) Filed: Dec. 20, 2001

(51) Int. Cl. B29C 70/72; B29C 45/14

(52) U.S. Cl. 425/123; 425/117

(57) ABSTRACT

A jig structure for an integrated circuit package. The jig structure is used for integrated circuits to be covered by glue. The jig structure includes a base formed with a plurality of receiving regions for receiving the integrated circuits, a mold plate covering the base, a plurality of glue inlets formed on the mold plate at locations corresponding to each receiving region on the base, and a projection arranged between each glue inlet and its corresponding receiving region. The projection blocks and buffers the glue entering the receiving regions from the glue inlets. According to the jig structure, the mold flow of the glue can be effectively buffered when the glue is poured. Thus, it is not necessary to redesign the jig with the change of the relative position relationships between the glue inlets and the integrated circuits. The jig of this invention can be widely used for packaging various integrated circuits having different sizes and specifications.

### BACKGROUND OF THE INVENTION

1. Field of the Invention

The invention relates to a jig structure for an integrated circuit package, in particular, to a jig capable of serving as the buffer for the mold flow during the process of glue pouring for the integrated circuit package. The invention also relates to a jig that can be widely used for various integrated circuit packages with different sizes.

2. Description of the Related Art

Referring to FIG. 1, in a conventional method for packaging the integrated circuits by way of glue pouring, a plurality of integrated circuits 10 are arranged within a plurality of receiving regions 14 of a jig 12. A plurality of glue inlets 16 are provided on the jig 12 for communicating with the corresponding receiving regions 14. The glue is poured into the receiving regions 14 from the glue inlets 16 so as to cover each integrated circuit 10 and thus complete the package processes for the integrated circuits 10.

However, in order to make the glue smoothly cover each integrated circuit 10, each glue inlet 16 is usually formed at the center position of each receiving region 14. Thus, when the glue enters the receiving regions 14 from the corresponding glue inlets 16 to cover the integrated circuits 10, the mold flow of the glue may uniformly cover each integrated circuit 10.

Referring to FIG. 2, it can be noted that the sizes of the integrated circuits 10 have been reduced. However, the same jig as that in FIG. 1 is used for the package process of glue pouring. Since the relative position relationships between the integrated circuits 10 and the glue inlets 16 are changed, the glue inlets 16 are no longer aligned with the center positions of the corresponding integrated circuits 10. Thus, during the package process of glue pouring, the mold flow of glue is not uniform. In this case, the package processes for the integrated circuits cannot be smoothly performed or the integrated circuits cannot be completely covered.

Consequently, when the sizes and specifications of the integrated circuits change, another jig usually has to be made so that the positions of the glue inlets 16 can be matched with the center positions of the integrated circuits 10. In this case, the glue can uniformly and smoothly cover the integrated circuits 10. However, the package cost may be correspondingly increased.

In view of the above-mentioned problems, it is an important object of the invetion to provide a jig structure for an integrated circuit package, which can be widely used for packaging various integrated circuits having different sizes and specifications. In additon, the mold flow of the glue during the glue pouring process can be uniformly balanced.

### SUMMARY OF THE INVENTION

It is therefore an object of the invention to provide a jig structure for an integrated circuit package, which can be widely used for packaging various integrated circuits having different sizes and specifications. The jig structure also can effectively decrease the package cost.

It is another object of the invention to provide a jig structure for an integrated circuit package, which can buffer and balance the mold flow.

To achieve the above-mentioned objects, there is provided a jig structure for an integrated circuit package. The jig structure is used for integrated circuits to be covered by glue. The jig structure includes a base formed with a plurality of receiving regions for receiving the integrated circuits, a mold plate covering the base, a plurality of glue inlets formed on the mold plate at locations corresponding to each receiving region on the base, and a projection arranged between each glue inlet and its corresponding receiving region. The projection blocks and buffers the glue entering the receiving regions from the glue inlets.

According to the jig structure, the mold flow of the glue can be effectively buffered when the glue is poured. Thus, it is not necessary to redesign the jig with the change of the relative position relationships between the glue inlets and the integrated circuits. The jig of this invention can be widely used for packaging various integrated circuits having different sizes and specifications.

### BRIEF DESCRIPTION OF THE DRAWINGS

These and other objects and advantages of the present invention will become apparent by reference to the following description and accompanying drawings wherein:

FIG. 1 is a cross-sectional top view showing a conventional jig structure for an integrated circuit package;

FIG. 2 is a cross-sectional top view showing the conventional jig structure for another integrated circuit package;

FIG. 3 is a cross-sectional top view showing a jig structure for an integrated circuit package of the invention; and

FIG. 4 is a cross-sectional side view showing the jig structure for the integrated circuit package of the invention.

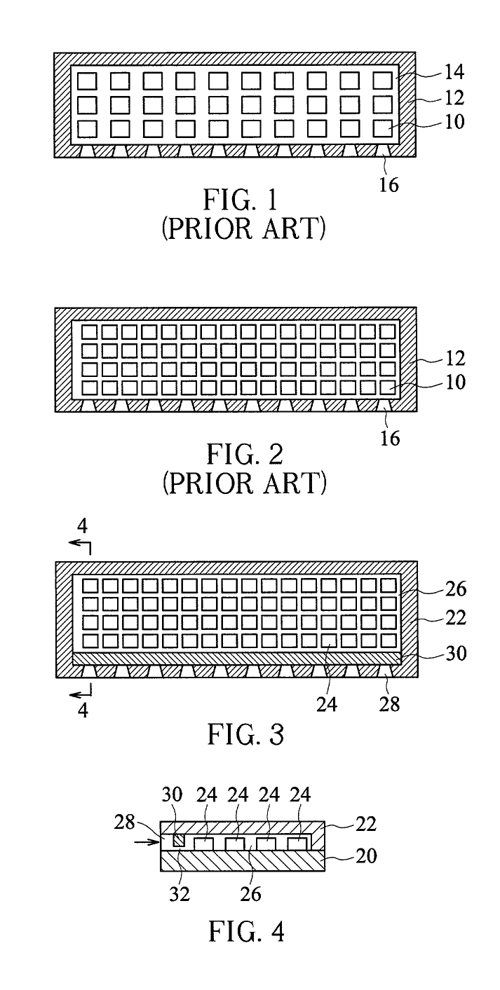

### DETAIL DESCRIPTION OF THE INVENTION

Referring to FIGS. 3 and 4, the jig structure for the integrated circuit package of the invention includes a base 20 and a mold plate 22. The base 20 is formed with a plurality of receiving regions 26 for receiving a plurality of integrated circuits 24. The mold plate 22 is placed on and covers the base 20. A plurality of glue inlets 28 are formed on the mold plate 22 at locations corresponding to each receiving region 26 on the base 20.

A strip-shaped projection 30 is arranged between each glue inlet 28 and its corresponding receiving region 26. Thus, when the glue enters the receiving regions 26 from the corresponding glue inlets 28, it is blocked by the projection 30 and flows into the receiving regions 26 to cover the integrated circuits 24 via apertures 32 formed between the projection 30 and the base 20. At this time, the glue smoothly flows into the receiving regions 26. The mold flow can be balanced by using the projection 30 as the buffer of the mold flow.

In case that the sizes and specifications of the integrated circuits 24 change, the glue inlets 28 on the mold plate 22 are not completely aligned with the center portion of each integrated circuit 24 when the integrated circuits 24 are placed on the base 20. Nevertheless, when the glue enters the receiving regions 26 from the corresponding glue inlets 28, it is blocked and buffered by the projection 30 and then flows into the receiving region 26. Thus, the mold flow of the glue can be balanced.

Consequently, the jig structure for the integrated circuit package of the invention can balance the mold flow by the buffering effect of the mold flow. The jig can be widely used for packaging various integrated circuits having different specifications and sizes. Therefore, the same jig can be used for various integrated circuits having different sizes. The manufacturing cost for the package is correspondingly low.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A jig structure for an integrated circuit package, the jig structure being used for integrated circuits to be covered by glue, the jig structure comprising:
a base formed with a plurality of receiving regions for receiving the integrated circuits;
a mold plate covering the base;
a plurality of glue inlets formed on the mold plate at locations corresponding to each receiving region on the base; and
a projection arranged between each glue inlet and its corresponding receiving region, wherein the projection blocks and buffers the glue entering the receiving regions from the glue inlets.

2. The jig structure for an integrated circuit package according to claim 1, wherein the projection on the mold plate is a strip-shaped projection.

3. The jig structure for an integrated circuit package according to claim 1, wherein the glue enters the receiving regions through apertures formed between the projection on the mold plate and the base.
